(19) United States
(12) Patent Application Publication
(10) Pub. No.: US 2025/0130076 A1
(43) Pub. Date: Apr. 24, 2025

(54) MITIGATING THE ACCUMULATIVE ERROR IN RELATIVE-MEASUREMENT DFOS

(71) Applicant: NEC Laboratories America, Inc., Princeton, NJ (US)

(72) Inventors: Jian FANG, Princeton, NJ (US); Ting WANG, West Windsor, NJ (US); Junyi YE, Monmouth Junction, NJ (US)

(73) Assignee: NEC Laboratories America, Inc., Princeton, NJ (US)

(21) Appl. No.: 18/901,690

(22) Filed: Sep. 30, 2024

Related U.S. Application Data
(60) Provisional application No. 63/591,186, filed on Oct. 18, 2023.

(51) Int. Cl. G01D 5/353; G01D 5/347

(52) U.S. Cl. CPC G01D 5/35364; G01D 5/34794

(57) ABSTRACT

Disclosed are systems, methods, and structures that mitigate accumulative error in relative-measurement DFOS by employing, for each segment of the DFOS arrangement that records a certain number of an earlier estimation of each spatial segment. A predictive model in each buffer learns trends from the recorded history and predicts an output from the previous history. The reference is also updated using the prediction from the buffer. Systems, methods, and structures according to the present disclosure include the buffer structure that records a certain number of earlier estimations for each segment, a predictive model in each buffer that predicts the output of each segment according to the earlier estimations, reference updates using the prediction from the buffer tracker and workflow of real-time data processing with the buffer structure and tracker.

### CROSS-REFERENCE TO RELATED APPLICATIONS

This application claims the benefit of U.S. Provisional Patent Application Ser. No. 63/591,186 filed Oct. 18, 2023 the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to the mitigation of accumulative error in relative-measurement DFOS.

### BACKGROUND OF THE INVENTION

Distributed fiber optic sensing (DFOS) systems, methods, and structures have found widespread utility in contemporary industry and society. The present invention and disclosure provide a DFOS arrangement and method that advantageously mitigates accumulative error in relative-measurement DFOS.

### SUMMARY OF THE INVENTION

An advance in the art is made according to aspects of the present disclosure directed to systems, methods, and structures that mitigate accumulative error in relative-measurement DFOS

In sharp contrast to the prior art, systems and methods according to aspects of the present disclosure employ for each segment of the DFOS arrangement that records a certain number of an earlier estimation of each spatial segment. A predictive model in each buffer learns trends from the recorded history and predicts an output from the previous history. The reference is also updated using the prediction from the buffer.

Viewed from multiple aspects our inventive systems, methods and structures include: the buffer structure that records a certain number of earlier estimations for each segment, a predictive model in each buffer that predicts the output of each segment according to the earlier estimations, reference updates using the prediction from the buffer tracker and workflow of real-time data processing with the buffer structure and tracker.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing an illustrative prior art method as compared with a method according to aspects of the present disclosure.

FIG. 3 is a plot of Relative Shifts vs Sample showing an illustrative example of accumulative error when updating a reference frame according to aspects of the present disclosure.

FIG. 4 is a schematic block diagram showing an illustrative buffer structure employed in systems, methods, and structures according to aspects of the present disclosure.

FIG. 5 is a schematic block diagram showing an illustrative example of a fitting model (polynomial) used as a predictive model according to aspects of the present disclosure.

FIG. 6 is a schematic block diagram showing an illustrative example of a tracking model (Kalman filter) used as a predictive model according to aspects of the present disclosure.

FIG. 7 is a plot of Accumulative Error vs Sample showing an illustrative example comparison between the classical method and our inventive method according to aspects of the present disclosure.

FIG. 8 is schematic block/flow diagram showing illustrative workflow of a real-time system according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

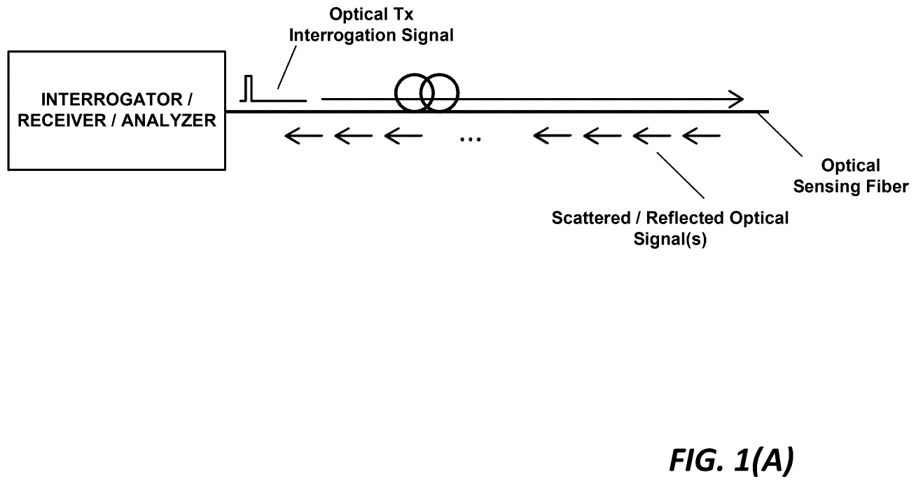

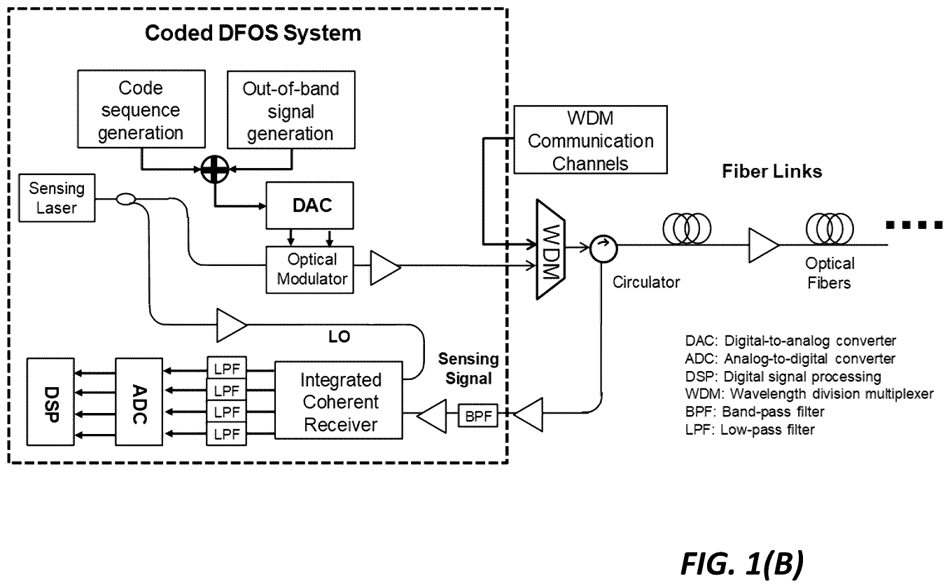

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DVS allows for continuous monitoring over long distances, but instead of measuring temperature, it measures vibrations and sounds along the fiber.

DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As the technology continues to develop, DAS/DVS is expected to become even more widely used in various fields where continuous and sensitive acoustic/vibration monitoring is crucial.

With the above in mind, we note that DFOSs can measure both “absolute” and “relative” physical parameters based on different principles. For instance, DFOS based on Raman backscattering can give the absolute temperature (in the unit of Kelvin or Celsius degree) along the fiber after calibration, while DFOS based on Rayleigh backscattering usually measures the relative change (temperature, strain, vibration, etc.) to a reference point.

Such type of “relative-measurement” DFOS provides the spatially resolved distributed monitoring of the change of certain physical quantities (also known as measurand) over the sensing fiber or cable, which can be retrieved as local temporal shifts in the backscattering signal (also known as trace). The relative change of measurand between the current trace and a previously required reference trace can be estimated through the cross-correlation, while the total change of measurand over time is determined by summing all the relative changes together.

For example, a “relative-measurement” DFOS using chirped-pulse phase-sensitive optical time-domain reflectometry, in which the received traces are separated into independent spatial segments with fixed length (corresponds to the pulse width and spatial resolution) has been described by M. R. Fernández-Ruiz, L. Costa, and H. F. Martins, in a paper entitled “Distributed Acoustic Sensing Using Chirped-Pulse Phase-Sensitive OTDR Technology,” that appeared in Sensors, vol. 19, no. 20, p. 4368 Oct. 2019.

The cross-correlation function is then employed to estimate the relative shift of each spatial segment from the reference captured beforehand. It is known that the reference of each spatial segment needs to be updated regularly when (1) the relative shift becomes too large to prone give inaccurate estimates or large errors, which is around 2% ˜4%, or (2) the correlation between current trace and the reference becomes too weak to prone give inaccurate estimates or large errors, which requires to update the reference after the certain elapsed time.

However, several critical challenges in such DFOS systems need to be resolved. First, the cross-correlation estimation will inevitably have estimation errors. When the reference is updated, the total change of measurand needs to add the current cross-correlation results. Therefore, such estimation errors will accumulate and grow over time, resulting in considerable accumulative errors which significantly degrade long-term performance.

Second, cross-correlation estimation has the probability to output large errors due to the measurement noise and system imperfections, which are anomalies that fundamentally affect the sensing accuracy. Third, the correlation between the reference and current trace will deteriorate over time due to the instability of the light source and modulation devices. Thus, the reference needs to be updated regularly, which will essentially exacerbate the issue of accumulative errors

As we shall show and describe, we present a novel technique to reduce the accumulative error. In contrast to any conventional methods, we create a buffer structure for each segment that records a certain number of the earlier estimation of each spatial segment. A predictive model in each buffer learns trends from recorded history and predicts an output from previous history (ies). The reference is also updated using the prediction from the buffer.

Features of particular interest include: the buffer structure records a certain number of earlier estimations of each segment; a predictive model in each buffer predicts the output of each segment according to the earlier estimations; a strategy of reference update using the prediction from the buffer tracker is employed; and the workflow of real-time data processing with the buffer structure and tracker is realized.

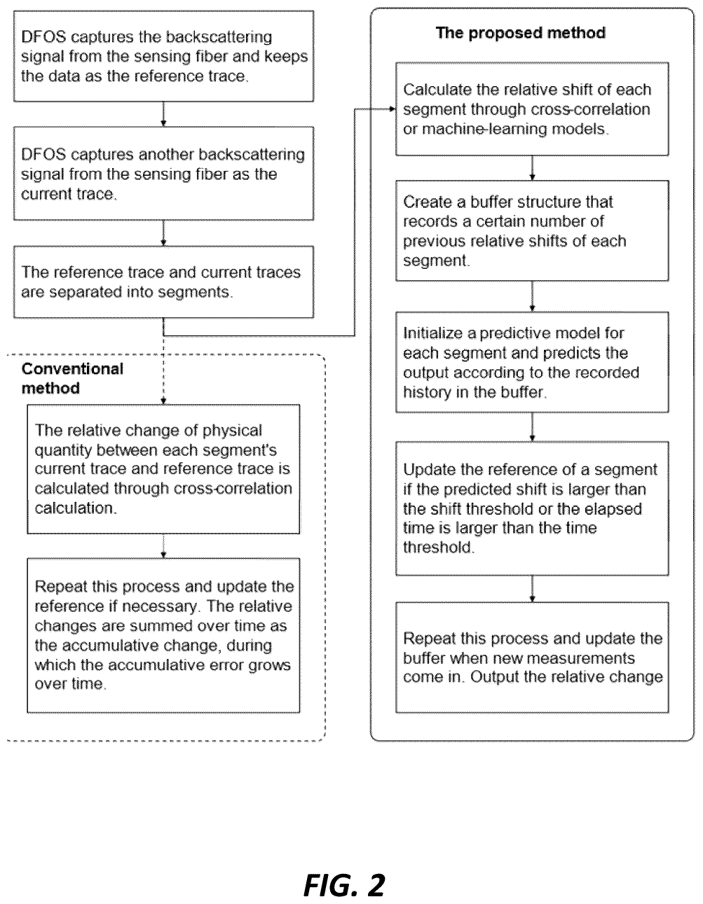

FIG. 2 is a schematic flow diagram showing an illustrative prior art method as compared with a method according to aspects of the present disclosure.

With reference to that figure, we note that a distributed fiber-optic sensing (DFOS) system described herein is referred to as a distributed optical sensor based on a scattering effect, such as the Rayleigh scattering or Brillouin scattering in an optical sensor fiber. A main type of DFOS we describe herein is based on the “relative measurement”, which includes (but is not limited to) coherent optical time-domain reflectometry (ϕ-OTDR), optical frequency-domain reflectometry (OFDR), Brillouin optical time-domain reflectometry (BOTDR), Brillouin optical time-domain analysis (BOTDA), Brillouin correlation-domain reflectometry (BOCDR), Brillouin correlation-domain analysis (BOCDA), etc.

The “relative measurement” relies on estimating the relative change, which could be a spatial shift or a spectral shift, or a peak shift, between consecutive traces and references using relative shift estimators. As an example, we mainly discuss herein the ϕ-OTDR with chirp-pulse. However, the idea and principle of this invention can be extended and applied to other DFOS systems including OFDR, BOTDR, BOTDA, BOCDR, BOCDA, etc.

As indicated in the figure, in a conventional method, the DFOS sends a train of modulated coherent pulses into the optical fiber, where each pulse produces a backscattering signal which reflects the status of the fiber. The DFOS system captures the backscattering signal from the pulse sent at the time to, and keeps the data as the reference trace X_{ref}[k], k=1,2, . . . , Nₛ. The DFOS system then captures another backscattering trace from the pulse sent at time t> to, and records it as the current trace X_{sig}[k], k=1, 2, . . . , Nₛ. Both X_{ref} and X_{sig} contain Nₛ sampling data points, corresponding to the fiber length and receiver sampling rate.

To analyze the relative change along the fiber between the current trace and the reference trace, X_{ref} and X_{sig} are separated into M segments, with a fixed segment length of N_{seg} and segment overlaps of Nₒᵥₑᵣₗₐₚ. The relative shift Δψ between each segment's current and reference trace is calculated through the shift estimators, including conventional cross-correlation (CC), cross-correlation (GCC), generalized cross-correlation (GCC), or GCC with phase transform (GCC-PHAT), least-square estimator, etc.

The process is repeated while updating the reference if necessary. Note that due to the noise and possible internal and external perturbations, the output of the shift estimator will inevitably contain certain random noise nₑₛₜ or even large errors n_{LE}. Therefore, when the reference trace is updated every time, the error will be added to the total change of measurand. In this way, the estimation error nₑₛₜ and large errors n_{LE} are summed over time, generating the accumulative error n_{acc} which grows over time.

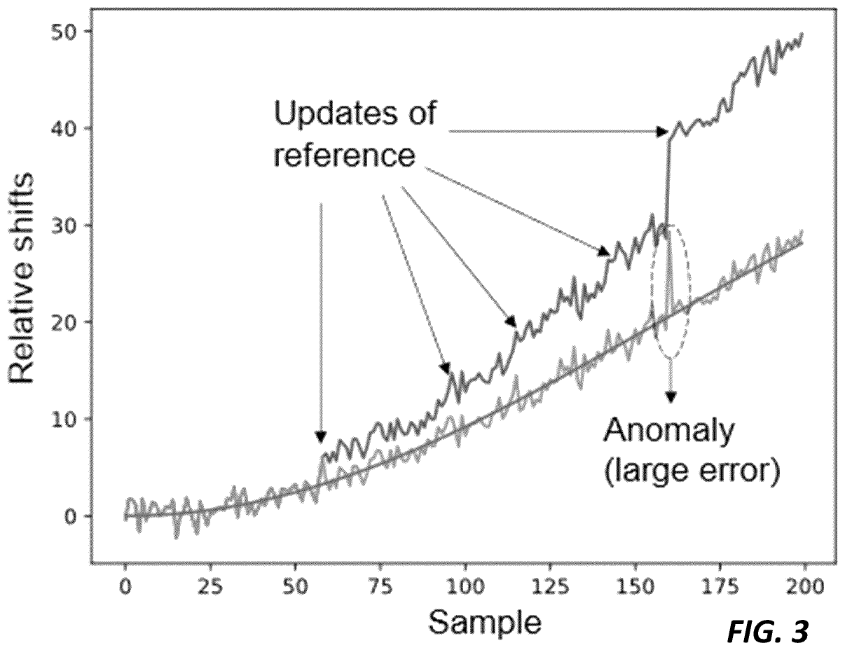

FIG. 3 is a plot of Relative Shifts vs Sample showing an illustrative example of accumulative error when updating a reference frame according to aspects of the present disclosure.

In that figure, one line denotes the “ground truth”, i.e., the real relative shift caused by physical variation (e.g., temperature change) over time, and the other line represents the estimation noise added to the ground truth. Note that since the maximum detectable range is limited, the reference needs to be updated when the relative shift exceeds a certain threshold. Therefore, the practical curve that a DFOS system obtains will be like the curve in FIG. 3 with a threshold of 4.

It is observed that when the reference is updated, the current value of estimation will be used as a new baseline, therefore introducing the extra noise from the estimation. The extra noise could also be severe where an anomaly occurs, such as a large error, which will cause jumps on the accumulated shifts that lead to serious deviation from the ground truth over the long-time operation.

As we discussed above, the accumulative error grows when the reference is updated. Therefore, any deviation from the ground truth at the updated reference, including both the estimation error and the large error, will contribute to the accumulative error, i.e.,

$${n}_{a c c} ( {N}_{u} , i ) = {\sum }_{k = 0}^{{N}_{u}} {n}_{est} ( k , i ) + {n}_{L E} ( k , i ) ,$$

where Nᵤ is the number of reference update times, i indicates the i-th segment. In the case of the estimation error being random and normally distributed, the accumulative error can be described as a Gaussian random walk process which depends on the number of reference update times and the noise. Therefore, the standard deviation (SD) will be

$${σ}_{a c c} = {σ}_{est} \sqrt{{N}_{u}} ,$$

where σₑₛₜ is the SD of the estimation error and Nᵤ is the number of reference update times. When there are large errors, which are quite common at low SNR segments or affected by some fast-varying perturbations, σ_{acc} would be increased considerably. Though the σₑₛₜ is bounded by the Cramer-Rao Lower Bound (CRLB), the actual SD may be larger than the CRLB which depends on the exact system configuration and cross-correlation algorithms.

To solve this problem, describe a novel technique to reduce the accumulative error. Instead of the conventional methods, we create a buffer structure for each segment that records a certain number of the earlier estimation of each spatial segment. There is a predictive model [symbol] in each buffer that learns the trend from the recorded history and predicts the output from the previous history. The reference is also updated using the prediction from the buffer.

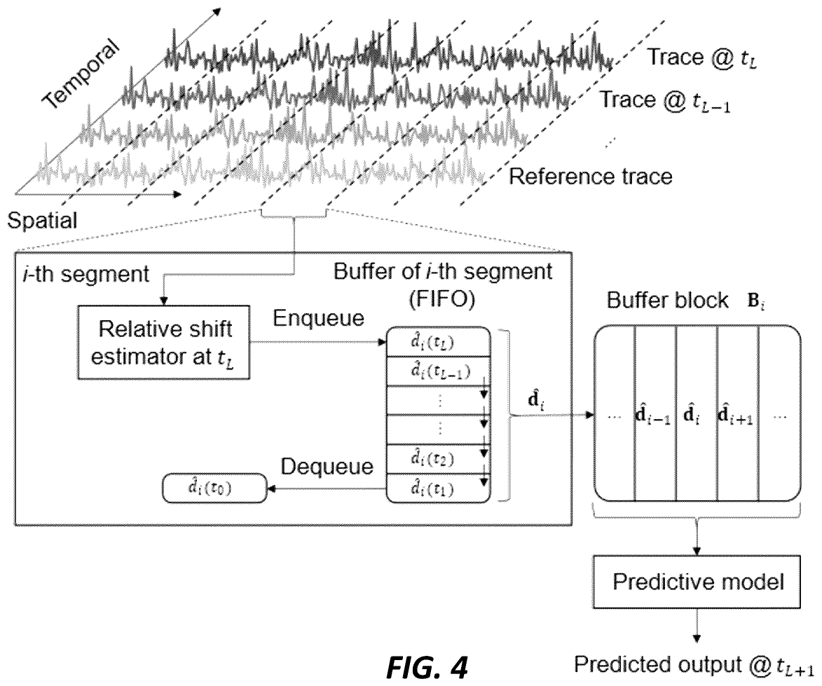

FIG. 4 is a schematic block diagram showing an illustrative buffer structure and flow of the buffer structure employed in systems, methods, and structures according to aspects of the present disclosure.

The backscattering data from the whole sensing range are divided into many spatial segments. For the i-th segments, the relative shift estimator calculates the shift of each trace captured at different times. The buffer of the i-th segment is typically an array structure \hat{d}ᵢ of length L which records previous L estimations and is organized following the first-in-first-out (FIFO) rule. For instance, the buffer of the i-th segment records the estimated shifts \hat{d}ᵢ(t₀), \hat{d}ᵢ(t₁), . . . , \hat{d}ᵢ(t_{L-1}) between the reference trace (which was obtained beforehand) and the traces captured at t₀, t₁, . . . , t_{L-1}. When a new trace is captured at time t_{L}, the latest estimated shift \hat{d}ᵢ(t_{L}) will be enqueued to the buffer top, while the earliest estimation \hat{d}ᵢ(t₀) will be dequeued from the buffer bottom. The buffer di of the i-th segment may be combined with neighboring segments, i.e. \hat{d}ᵢ₋₁, \hat{d}ᵢ₊₁ or more segments, as a buffer block Bᵢ, which is fed into the predictor to proceed, as shown in FIG. 4.

The predictive model is a functional structure that can learn the trend from the history data in a buffer or buffer block and give a robust prediction as the output. It could be a fitting model (such as the least square fitting or the polynomial fitting), a tracking filter (including the g-h filter or the Kalman filter), or a machine-learning model (including the deep neural network, the convolutional neural network, the recurrent neural network, etc.).

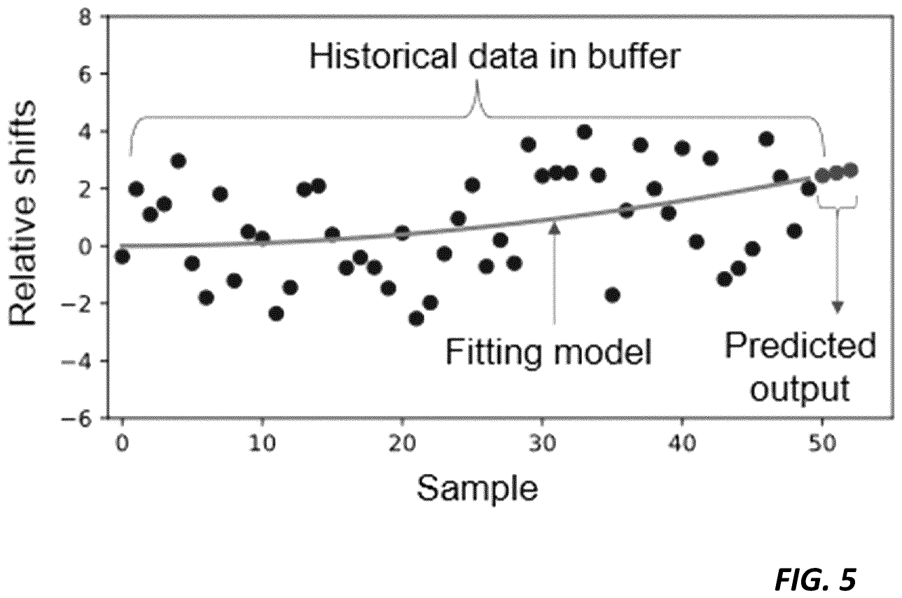

FIG. 5 is a schematic block diagram showing an illustrative example of a fitting model (polynomial) used as a predictive model according to aspects of the present disclosure.

In the case of a fitting model being used as the predictive model, the buffer data or the buffer block is used as the historical data, as shown in FIG. 5. Depending on the actual application, the fitting model F(·) can be a least square fitting, a polynomial fitting, or other more complex models. The parameters of the model are updated adaptively to minimize the metric (e.g., mean squared error, MSE, etc.) using L historical data and predict the output at the new time t_{L+1}. If the fitting model is chosen properly, the variance of the predicted output is given the covariance matrix Q=σₑₛₜC⁻¹, where C is the Hessian matrix of the fitting.

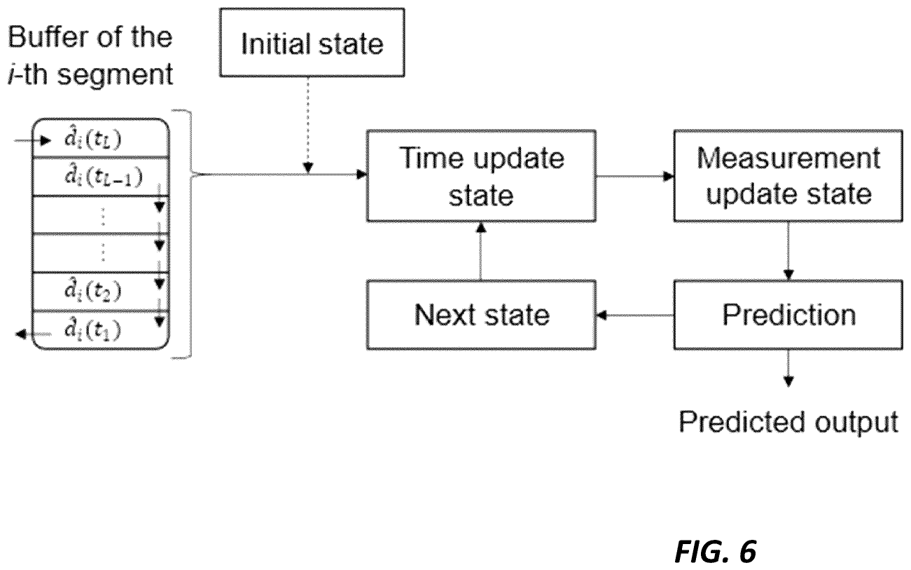

In the case of a tracking filter being used as the predictive model, the buffer data or the buffer block is used as the prior knowledge of the state with L previous observations. Each segment is modeled as a dynamic system following the physical law of motion. The initial states of the system will be determined first, followed by the time update states. In the measurement update states, the noisy input will be considered, and the shifts at the next timestamp will be predicted. The tracking filter keeps track of the estimated state of the system and the variance of the uncertainty of the estimate, as shown in FIG. 6, which is a schematic block diagram showing an illustrative example of a tracking model (Kalman filter) used as a predictive model according to aspects of the present disclosure.

In the case of a machine learning model being used as the predictive model, it may be necessary to store a certain amount of buffer data to form a training dataset. The problem is like the time-series prediction, so a Recurrent Neural Network (RNN) or a Long Short-Term Memory network (LSTM) model will be a good fit. It is noted that the buffer is updating over time so the training dataset should also be updated with the buffer. Therefore, the ML models should be “adaptive” to the change of the various buffer data or buffer blocks.

The accumulative error using our proposed method is now expressed as

$${n}_{a c c} ( {N}_{u} , i ) = {\sum }_{k = 0}^{{N}_{u}} {n}_{p r e} ( k , i ) ,$$

where nₚᵣₑ is the predicted noise. Since we're using the historical data in the buffer to learn the trend and make predictions under reasonable physical state conditions, the predicted noise would be much lower than the original estimation error. Meanwhile, large errors (LEs) can be identified as anomalies and discarded by the predictive models. Therefore, there is no n_{LE} any more in the accumulative error.

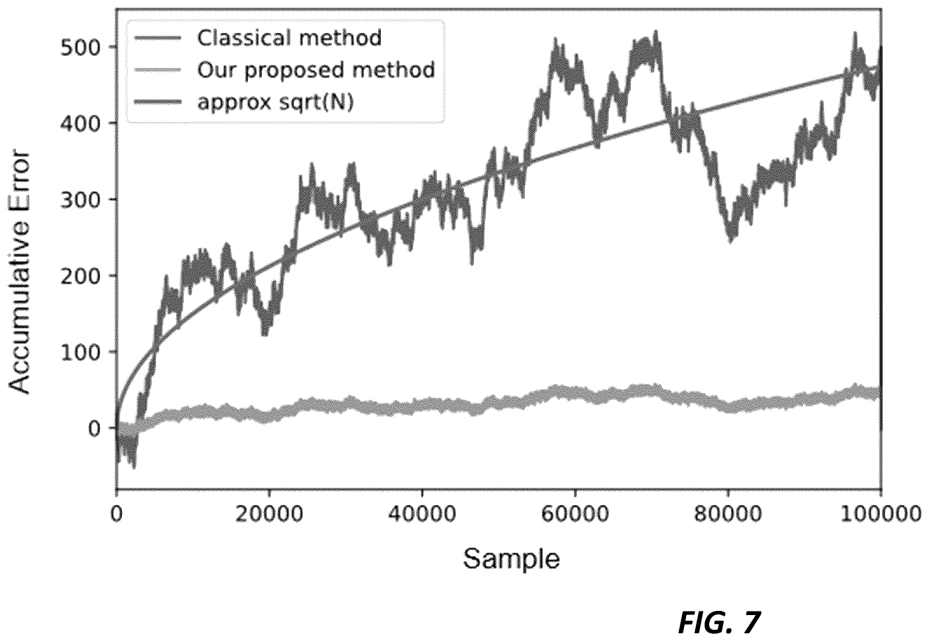

FIG. 7 is a plot of Accumulative Error vs Sample showing an illustrative example comparison between the classical method and our inventive method according to aspects of the present disclosure.

FIG. 7 illustrates the comparison between the classical method and our proposed method in the accumulative error. With the classical method, the error grows over time and matches the approximate \sqrt{N} trend. However, by applying the proposed method in this IR, the accumulative error has been mitigated significantly. This result shows the effectiveness and robustness of our technique.

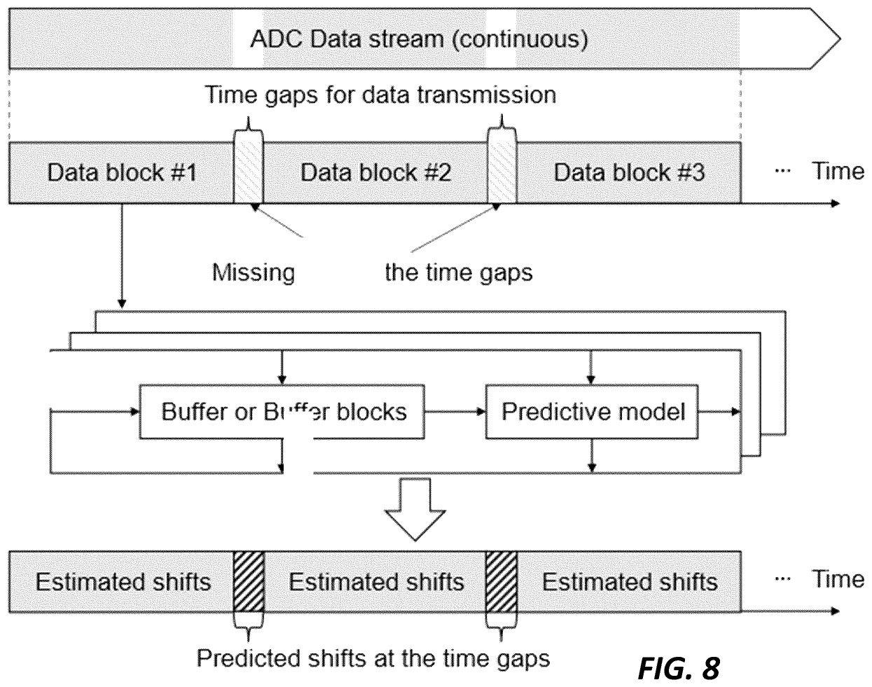

In a real-time system, the optical sensing data were converted into electrical signals through a photo-detector and captured by the analog-to-digital converter (ADC). Consider a realistic system in that data are continuously streaming from the ADC and digitizer, the transmission of data from the FPGA to the controller or computer still needs some time, leaving the time gaps in which portion of the data are not recorded, as shown in FIG. 8.

FIG. 8 is schematic block/flow diagram showing illustrative workflow of a real-time system according to aspects of the present disclosure.

Though there are some methods which can seamlessly stream the data, the cost, and complexity will be significantly increased. In our inventive scheme, the buffer or buffer block will store the data block per transmission, meanwhile, the predictive model will learn the trend of measurand change using a certain length of buffer data and give the output as estimated shifts. At the time gaps where a portion of data is missing, the predictive model will fill in these gaps with predicted shifts at these timestamps so that the output data stream will be seamless. This is reasonable when the gap time is much shorter than the data block time so that the measurand change would be predictable during the gaps. In this way, the proposed technique can stream the robust output measurement seamlessly without any time gap, which would be extremely useful in many applications.

While we have presented our inventive concepts and description using specific examples, our invention is not so limited. Accordingly, the scope of our invention should be considered in view of the following claims.

1. An improved computer implemented method for relative measurement distributed fiber optic sensing (DFOS), the method comprising:
by the computer:
separating a DFOS reference trace and a current trace into segments:
determining a relative shift of each segment;
recording a plurality of relative shifts of each segment;
initializing a predictive model for each segment;
updating a reference of a segment according to a predetermined criteria;
repeating the above determining, recording, initializing, and updating steps upon receipt of new DFOS measurements and
outputting a determined relative change relative shifts.

2. The method of claim 1 wherein the determining of the relative shift of each segment is performed by at least one of cross-correlation or machine learning models.

3. The method of claim 2 wherein the recording of the relative shifts includes creating a buffer that records the relative shifts of each segment.

4. The method of claim 3 wherein the predictive model predicts a predicted shift according to the relative shifts recorded in the buffer.

5. The method of claim 4 wherein the segment reference is updated if the predicted shift is larger than a shift threshold or an elapsed time is larger than a time threshold.
